(19) United States
(12) Patent Application Publication
(10) Pub. No.: US 2017/0316714 A1
(43) Pub. Date: Nov. 2, 2017

(54) EDUCATION SYSTEM USING VIRTUAL ROBOTS

(71) Applicant: Kam Ming LAU, HongKong (HK)

(72) Inventor: Kam Ming LAU, Hong Kong (HK)

(21) Appl. No.: 15/497,236

(22) Filed: Apr. 26, 2017

(30) Foreign Application Priority Data
Apr. 27, 2016 (HK) 16104845.1

(51) Int. Cl. G09B 19/00

(52) U.S. Cl. CPC G09B 19/0053

(57) ABSTRACT

An education system comprising a control device, a physical toy, and a virtual toy, wherein the physical toy is used to communicate with the control device, and the control device is used to created the virtual toy, the virtual toy and the control device are used for programming, the virtual toy is a counterpart of the physical toy, the virtual toy of the physical toy is integrated in virtual world.

### CROSS-REFERENCE TO RELATED APPLICATIONS

This application claims priority to Hong Kong Patent Application No. 16104845.1 with a filing date of Apr. 27, 2016. The content of the aforementioned application, including any intervening amendments thereto, are incorporated herein by reference.

### TECHNICAL FIELD

The present disclosure generally relates to a computer programming education tool and, in particular relates to an educational system consisting of a plurality of virtual robots, a plurality of physical robots, a tablet computer and a cloud service for programming.

### BACKGROUND OF THE PRESENT INVENTION

At present, an increasing number of people choose electric learning to study new knowledge, electric learning is also called the E-learning, which provides educational activities by using computers and internet, and makes full use of information technology to provide a kind of new way of learning. With the development of the virtual reality technology, it is possible to make use of virtual robots into educational system by using computer programming to make student learn effectively and efficiently.

### SUMMARY OF PRESENT INVENTION

In accordance with one aspect of the disclosure, an education system is disclosed. The education system may comprise a control device, a physical toy, and a virtual toy, wherein the physical toy is used to communicate with the control device, and the control device is used to created the virtual toy, the virtual toy and the control device are used for programming, the virtual toy is a counterpart of the physical toy, the virtual toy of the physical toy is integrated in virtual world.

In accordance with an alternative or additional aspect of the disclosure, an education system is disclosed. The education system may comprise a control device, one or more physical toys, and one or more virtual toys, wherein the physical, toys are used to communicate with the control device, and the control device is used to create the virtual toys, the virtual toys and the control device are used for programming, and the virtual toy is equipped with movable parts that are used to be controlled by the control device, the virtual toy is further equipped with sensor parts that are used to send signals and triggers to the control device, each virtual toy is integrated alone in a virtual world or used to connect to a corresponding counterpart physical toy in real world, the control device is further used to opt to connect to a physical toy or a virtual toy, and the control device is used to decide how many virtual toys integrated in the virtual world, the control device is used to integrate multiple virtual toys by using different translators.

The illustrated education system may further comprise a server and a software application, wherein the server is used to save translators, stencils programs and other information to facilitate a lesson or/and provide download service, the control device is used to choose different virtual world with different educational settings, the software application is configured to utilize processing power of the control device to perform functions that are not available in the physical toy, the software application is configured to utilize computer vision function and image process function to build new educational blocks in a Visual Programming Language (VPL) software, the new educational blocks are used for voice recording and music playback, while the physical toy is used, to capture video stream, the software application is used to link with several classes and, instances of virtual toys simultaneously in a lesson, and the control device further comprising a Visual Programming Language (VPL) programming, and the VPL programming is used to switch to different virtual toys or physical toys, the virtual world is used to share among different users in different schools, the virtual world is used to provide competition or social activities, one or more virtual robots in the virtual world are used to be programmed by one user, the virtual robots are used to hold educational and entertainment competitions in virtual world, the physical robots are used to hold educational and entertainment competitions in real world.

The illustrated education system may further comprise a sensor, the sensor is used to detect signals and send the detected signals to another virtual toy in the control device, the sensor is a gesture sensor, the gesture sensor is used to receive dancing gesture signals and send the dancing gesture signals to the virtual toy, and the virtual toy is commanded by the dancing gesture signals, the gesture sensor is used to receive dancing gesture signals created by different user who dance, simultaneously before the gesture sensor.

Other advantages and features will be apparent from the following detailed description when read in conjunction with the attached drawings.

### DESCRIPTION OF THE DRAWINGS

For a more complete understanding of the disclosed education system, reference should be made to the embodiments illustrated in greater detail in accompanying drawing, wherein:

FIG. 1 is an embodiment of an education system constructed in accordance with the teachings of the disclosure;

FIG. 2 is another embodiment of an education constructed in accordance with the teachings of the disclosure.

It should be understand that the drawings are not necessarily to scale and that the disclosure embodiments are sometimes illustrated diagrammatically and in partial views. In certain instances, details which are not necessary for an understanding of the disclosed system, or which render other details difficult to perceive, may have been omitted. It should be understood, of course, that this disclosure is not limited to the particular embodiments illustrated herein.

### DETAILED DESCRIPTION OF PREFERRED EMBODIMENTS

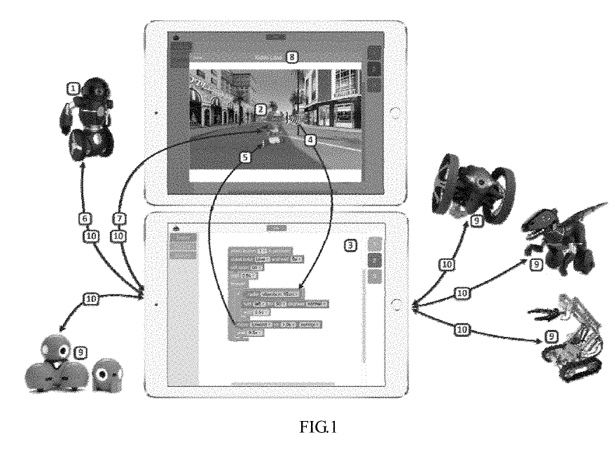

Referring now to the drawing, and with specific reference to FIG. 1, an education system may compromise a control device, a physical toy in real world, Visual Programming Language (VPL) interpreter, a cloud service system comprising a cloud server, and a virtual toy in virtual word created by the control device. The physical toy is automation device or physical robot or toy robot which can communicate with the control device. The virtual toy, the VPL interpreter, the cloud sever and the control device are used for programming, wherein the control device is a tablet computer or a similar computer system or a virtual reality device.

In the illustrated embodiment, a physical toy (1) has a corresponding software 3D model (2) which lives in virtual world (8), wherein the software model (2) is also called virtual robot or, virtual toy. The virtual robot (2) is equipped with movable parts that can be controlled, by first computer programming (3) integrated in the control device, wherein the first computer programming (3) is written by Visual Programming Language (VPL) Some examples of VPL software are Scratch from MIT Media Lab and Google Blockly. In addition, the virtual robot (2) is equipped with sensor parts, that can send signals and triggers to the control device, and the virtual robot (2) is also equipped with actuators (5) which have the similar functions with its physical world counterpart. The virtual toy is integrated alone in a virtual world or used to connect to a corresponding counterpart physical toy in real world. The control device is further used to opt to connect to a physical toy or a virtual toy.

In addition, the education system can integrate multiple virtual toys by using different translators, one or more virtual toys are further integrated in the virtual world, the control device is used to choose different virtual world with different educational settings. The control device is further used to decide how many virtual toys integrated in the virtual world, and one or more virtual toys are integrated in the virtual world.

As shown in FIG. 1, the disclosed education system also, has second computer programming (4) integrated in the control device. When the virtual robot (2) sends signals and triggers by sensor parts, the second computer programming (4) receives the signals and triggers.

The control device can opt to connect to a physical robot (6) or a virtual robot (7) to perform third computer programming which is a Visual Programming Language (VPL) programming. In addition, the virtual robot (2) is resided inside a virtual world (8), and the virtual world is different in different educational settings, for example, different courses and lessons would have a different virtual world. Translators, Stencils, Programs and other information to facilitate a lesson can be saved and/or downloaded from a server according to user accounts. When the lessons need, one or more virtual robots (9) can reside in one virtual world, and user can switch to different robots by using the third computer programming (10) which is a VPL programming.

The same Virtual World can be shared among students, tutors, or even students and tutors in different schools. When they enter the same virtual world, competition or social activities can happen. The virtual world system that links different users onto the same virtual world can compete and socialize by using virtual robots programmed by VPL. The virtual world is used to provide competition or social activities, one or more virtual robots in the virtual world are used to programmed by one user, the virtual robots are used to hold educational and entertainment competitions in virtual world, the physical robots are used to hold educational and entertainment competitions in real world.

At the same time, there are real robots in physical world belonged to the different users. By control of the real robots, the users can compete and socialize with each other through corresponding virtual robots. In the illustrated embodiment, the education system may compromise a software application. The software application can link with several classes and instances of virtual toys simultaneously form a lesson. The software application also can utilize processing power of the control device to perform function that is not available in the physical toy ([0014]), for example, using computer vision function and image process function to build new educational block in the VPL software while the physical toy ([0014]) can only capture video stream, the new educational blocks can use for voice recording and music playback, etc, the VPL software is Scratch from MIT Media Lab. or Google Blockly.

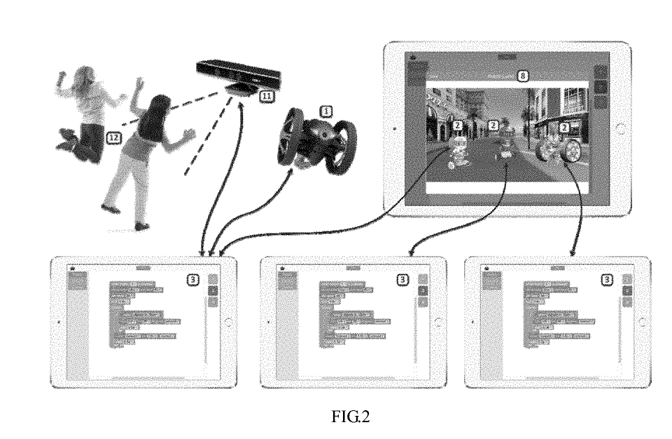

Referring now to FIG. 2, another embodiment of an education system in accordance with the teachings of the disclosure is constructed. In the embodiment, the education system comprises a control device, a physical toy (1), one or more virtual robots (2), the first computer programming (3), the virtual world (8), and a gesture sensor (11), and one or more users (12). The virtual world (8) has many virtual robots (2), and one or more virtual robots (2) can be programmed by one user (student or tutor). It is also possible that the user (student or tutor) connects to another virtual robot in, the same control device at the same time by using a sensor (11). For example, the virtual robot is commanded by a user (12) doing dancing in front of a gesture sensor in real world, and the gesture sensor is used to receive dancing gesture signals created, by different user who dance simultaneously before the gesture sensor, wherein the gesture sensor can be a Kinect, The disclosed invention can extend to Virtual Reality (VR) apparatus (like Oculus) in place of control device (like iPad, and tablet computer) for viewing of the virtual robots and virtual world.

While only certain embodiments have been set forth, alternatives and modifications will be apparent from the above description to those skilled in the art. These and other alternatives are considered equivalents and within the spirit and scope of this disclosure and the appended claims.

I claim:

1. An education system comprising a control device a physical toy, and a virtual toy, wherein the physical toy is used to communicate with the control device, and the control device is used to created the virtual toy, the virtual toy and the control device are used for programming, the virtual toy is a counterpart of the physical toy, the virtual toy of the physical toy is integrated in virtual world.

2. The education system of claim 1, wherein the control device is a tablet computer or a similar computer system or a virtual reality device, and the virtual toy is equipped with movable parts that are used to be controlled by the control device, and the virtual toy equipped movable actuators provides same functions as its physical world counterpart.

3. The education system of claim 2, wherein the virtual toy is further equipped with sensor parts that are used to send signals and triggers to the control device, the virtual toy is integrated alone in a virtual world or used to connect to a corresponding counterpart physical toy in real world, the control device is further used to opt to connect to a physical toy or a virtual toy.

4. The education system of claim 1, further comprising a server, wherein the server is used to save translators, stencils, programs and other information to facilitate a lesson and/or provide download service, and one or more virtual toys are further integrated in the virtual world, the control device is used to choose different virtual world with different educational settings, and the control device is used to decide how many virtual toys integrated in the virtual world, one or more virtual toys are integrated in the virtual world.

5. The education system of claim 4, further comprising a software application, wherein the software application is, used to link with several classes and instances of virtual toys simultaneously in a lesson, and utilize processing power of the control device to perform function that is not available in the physical toy, and the control device further comprising a Visual Programming Language (VPL) programming, and the VPL programming is used to switch to different virtual toys or physical toys.

6. The education system of claim 5, wherein the the virtual world is used to share among different users in different schools, the virtual world is used to provide competition or social activities, one or more virtual robots in the virtual world are used to programmed by one user, the virtual robots are used to hold educational and entertainment competitions in virtual, world, the physical robots are used to hold educational and entertainment competitions in real world.

7. An education system of claim 6, further comprising a sensor, wherein the sensor is used to detect signals and send the detected signals to another virtual toy in the control device, and the sensor is a gesture sensor, the gesture sensor receives dancing gesture signals and sends the dancing gesture signals to the virtual toy, and the virtual toy is commanded by the dancing gesture signals.

8. An education system comprising a control device, one or more physical toys, and one or more virtual toys, wherein the physical toys are used to communicate with the control device, and the control device is used to create the virtual toys, the virtual toys and the control device are used for programming, and the virtual toy is equipped with movable parts that are used to be controlled by the control device, the virtual toy is further equipped with sensor parts that are used to send signals and triggers to the control device, each virtual toy is integrated alone in a virtual world or used to connect to a corresponding counterpart physical toy in real world, the control device is further used to opt to connect to a physical toy or a virtual toy, the control device is used to decide how many virtual toys integrated in the virtual world, the control device is used to integrate multiple virtual toys by using different translators.

9. An education system of claim 8, further comprising a server and a software application, wherein the server is used to save translators, stencil programs and other information to facilitate a lesson or/and provide download service, the control device is used to choose different virtual world with different educational settings, the software application is configured to utilize processing power of the control device to perform functions that are not available in the physical toy, the software application is configured to utilize computer vision function and image process function to build new educational blocks in a Visual Programming Language (VPL) software, the new educational blocks are used for voice recording and music playback, while the physical toy is used to capture video stream, the software application is used to link with several classes and instances of virtual toys simultaneously in a lesson, and the control device further comprising a Visual Programming Language (VPL) programming, and the VPL programming is used to switch to different virtual toys or physical toys, the virtual world is used to share among different users in different schools, the virtual world is used to provide competition or social activities, one or more virtual robots in the virtual world are used to programmed by one user, the virtual robots are used to hold educational and entertainment competitions in virtual world, the physical robots are used to hold educational and entertainment competitions in real world.

10. An education system of claim 9, further comprising a sensor, the sensor is used to detect signals and send the detected signals to another virtual toy in the control device, the sensor is a gesture sensor, the gesture sensor is used to receive dancing gesture signals and send the dancing gesture signals to the virtual toy, and the virtual toy is commanded by the dancing gesture signals, the gesture sensor is used to receive dancing gesture signals created by different user who dance simultaneously before the gesture sensor.
